(19) United States
(12) Patent Application Publication
(10) Pub. No.: US 2008/0015922 A1
(43) Pub. Date: Jan. 17, 2008

(54) METHOD AND USER INTERFACE FOR COMPUTER-ASSISTED SCHEDULE COORDINATION

(76) Inventor: Yoram Nelken, San Francisco, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/778,506

(22) Filed: Jul. 16, 2007

Related U.S. Application Data
(63) Continuation-in-part of application No. 11/364,168, filed on Mar. 1, 2006.
(60) Provisional application No. 60/657,563, filed on Mar. 1, 2005.

(51) Int. Cl. G06Q 10/00; G06F 17/00

(52) U.S. Cl. 705/8

(57) ABSTRACT

A computer-implemented method includes reserving blocks of time reflecting a user's selection of one or more proposed meeting times and dates in the user's electronic calendar. Contemporaneously with the user's selections, an e-mail form specifying the proposed meeting times and dates is created. This e-mail form is then transmitted, in response to user command, and specifies the proposed meeting times and dates to one or more invitees. The proposed meeting times and dates may further be transmitted to a server where a virtual meeting instance may be created according to the proposed meeting times and dates.

### RELATED APPLICATIONS

The present application is a continuation-in-part of and claims priority to U.S. patent application Ser. No. 11/364,168, filed Mar. 1, 2006, which claims priority to U.S. Provisional Patent Application No. 60/657,563, filed Mar. 1, 2005, each of which are incorporated herein by reference.

### FIELD OF THE INVENTION

The present invention relates to a computer-assisted methods and systems for scheduling and managing multi-user events or activities and, in particular, to a graphical user interface useful for such scheduling and management.

### BACKGROUND

Desktop office automation tools deployed on personal computers have improved productivity and enabled businesses to reduce overhead associated with administrative support staff, but such tools have not streamlined the recurrent process of organizing and scheduling meetings, particularly where a meeting initiator and one or more proposed invitees are from multiple enterprises. In the past, multi-person meetings, activities, conferences, etc., were organized by administrative personnel assigned to such tasks. Often, these individuals would have to initiate and participate in multiple communications with event attendees in order to ensure that all attendees' schedules were properly accommodated. Today, business often cannot afford to employ these administrators, yet the process of organizing/scheduling meetings or other multi-participant is no less complex than before.

Personal information management (PIM) software programs such as Microsoft Outlook™ have addressed this problem to a limited extent by providing a calendar packaged with an e-mail program. The calendar can be used to keep track of individual appointments and, to a degree, to schedule meetings and issue invitations to prospective participants for upcoming events. Typically, however, this desktop software tool cannot be used (at least not efficiently) to negotiate a best time and/or place for a meeting. For example, and especially where multiple participants are involved, a typical negotiation of this nature may involve many e-mail exchanges between the various participants as each tries to accommodate his/her own existing appointment schedule and propose meeting times/locations that meet those needs. Of course, because the different participants often have no knowledge of the others' existing appointment schedules these proposals are often unacceptable and counter-proposals must be made. It is not unusual for multiple exchanges of this type to be required, even when only a relatively few number of participants are involved, before a meeting time/location can be agreed upon.

In some cases, the Microsoft Outlook™ tool can be configured to permit multiple subscribers to a common network to share their calendars with one another if they so choose. This allows network users other than a calendar owner to view free/busy times for that calendar owner. Hence, in the multi-participant meeting example above, if various ones of the meeting participants are members of a common organization and have been provided with access to one another's calendars, some of the e-mail negotiation process may be shortened because a meeting organizer can propose times that accommodate not only the organizers schedule but also coincide with available times as reflected in others' calendars. However, this does not solve the situation where users do not subscribe to a common network and/or do not share calendar information with one another.

Microsoft Outlook™ has a companion enterprise (i.e., server-based) product, Microsoft Exchange™, which sometimes facilitates meeting scheduling through the provision of shared user calendars. Of course, other client-server applications, such as IBM's Domino™ and Notes™, provide similar features. However, this approach is of limited use for at least two reasons. First, the meeting initiator and all invitees must be on the same Microsoft Exchange™ server in order for the initiator to view free/busy time of the invitees, a requirement that is very rarely met in real scheduling circumstances. Moreover, the Outlook/Exchange information must be up to date in order to be useful. Second, sharing of calendars is not sufficient for actually scheduling a meeting. An individual's previously-calendared appointments often are not the only factor considered when that individual (or his/her designee) decides whether or not to consent to a newly-proposed meeting. That is, even when sharing of free/busy time is made possible, the scheduling problem is not resolved because the mere fact that a person does not already have a commitment scheduled in a specific timeslot does not mean s/he will agree to a particular meeting with the requestor. Likewise, solely because a person is “busy” (as reflected by an existing appointment entry in an electronic calendar) does not necessarily mean that person will decline an invitation from another person to an alternative event.

Making calendar data available outside an organization is not a trivial issue. For example, often one does not want outsiders to know when one is free or busy, and certainly not to be able to see what projects or clients one is devoting one's time to. Any technological solution would have to address confidentiality issues of this nature.

Furthermore, solutions that allow sharing of data amongst numerous people are vulnerable to unwanted multiplication of that data. For example, electronic data can be easily transmitted to large user lists, etc., without the data owner's consent or knowledge. Vulnerabilities of this kind need to be addressed in any solution.

As an additional complication, once an activity is scheduled and confirmed, there could still be events that affect the activity, including invitees who change their mind, new documents or other data which becomes available after the scheduling has occurred, etc. There is no simple way to manage such changes or updates with existing solutions.

Finally, any computer-assisted schedule coordination tool must be compatible with a user's existing work environment and accustomed way of interacting with others. Stated differently, such tools should overlay on, rather than replace, a user's existing PIM software tools and be consistent with the user's social and business hierarchies and relationships.

### SUMMARY OF THE INVENTION

In light of the above-described deficiencies of conventional methods for coordinating and scheduling meetings, the present invention provides a computer-assisted method for coordinating activities between a user and one or more invitees.

One embodiment of the invention provides a computer-implemented method that includes reserving, in an electronic calendar and in response to selection by the user of one or more proposed meeting times and dates in said calendar, blocks of time reflecting the user's selection as proposed meeting times/dates; creating, contemporaneously with the user's selections, an e-mail form specifying the proposed meeting times and dates; and transmitting, in response to user command, the e-mail form specifying the proposed meeting times and dates to the one or more invitees. The proposed meeting times and dates may be transmitted to a server where a virtual meeting instance may be created according to the proposed meeting times and dates.

A further embodiment of the invention provides a graphical user interface that includes an e-mail form and a dynamically linked calendar view, the calendar view permitting selection by a user of one or more times/dates for a multi-person event and the e-mail form including a proposed meeting form that is dynamically updated to reflect the user's selection of the one or more times/dates for the multi-person event. The calendar view may include an uncondensed view of at least a portion of a selected day and a condensed view of multiple adjacent days to the selected day, each view including the user's free/busy time for a respective day. Further, the email form may include a field for text to be entered by the user.

Yet another embodiment of the invention provides a computer-implemented method in which a user's electronic calendar is updated to reflect selections by one or more meeting invitees of proposed meeting times/dates, such selections being made through a server other than that hosting an instance of the user's electronic calendar. These selections by the meeting invitee's may include acceptance, rejection, or preference indications concerning the proposed meeting times/dates. The proposed meeting times may be presented to the invitees via e-mail messages soliciting responses to the proposed meeting times/dates and may include proposed meeting fields having the proposed meeting times/dates. These proposed meeting times/dates may be entered in the proposed meeting fields automatically in response to user selection of same in the user's electronic calendar. A view of the user's electronic calendar may be presented concurrently with a e-mail form including the proposed meeting fields so as to facilitate this user selection activity.

Implementation of the methods and systems of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The present invention is illustrated by way of example and not limitation in the figures of the accompanying drawings, in which:

FIG. 1 is a flow chart of a computer assisted method for scheduling events according to one embodiment of the present invention.

FIG. 2 is a screen shot showing an example of a graphical interface screen provided by an implementation of the present invention.

FIG. 3 is a screen shot showing an example of another graphical interface screen provided by an implementation of the present invention.

FIG. 4 is a block diagram illustrating a system adapted to practice one embodiment of the present invention wherein free/busy information from multiple participants are accessible to a trusted server

FIGS. 5-8 are screen shots illustrating various examples of graphical interface screens provided in accordance with an implementation of the present invention.

### DETAILED DESCRIPTION

Described herein are computer-assisted methods and systems for scheduling and managing multi-user events or activities and, in particular, a graphical user interface useful for such scheduling and management. In reviewing this description it should be understood that the present invention is not limited in its application to the details of construction or programming and the arrangement of the components described below or illustrated in the drawings. Indeed, the present invention is capable of being implemented in other embodiments and/or of being practiced or carried out in various ways. Stated differently, the present invention is not intended to be limited by the description of any specific examples or use of any particular illustrations, which examples and illustrations are intended only to enhance understanding of the invention. Also, it is to be understood that the phraseology and terminology employed herein is for the purpose of description and should not be regarded as limiting.

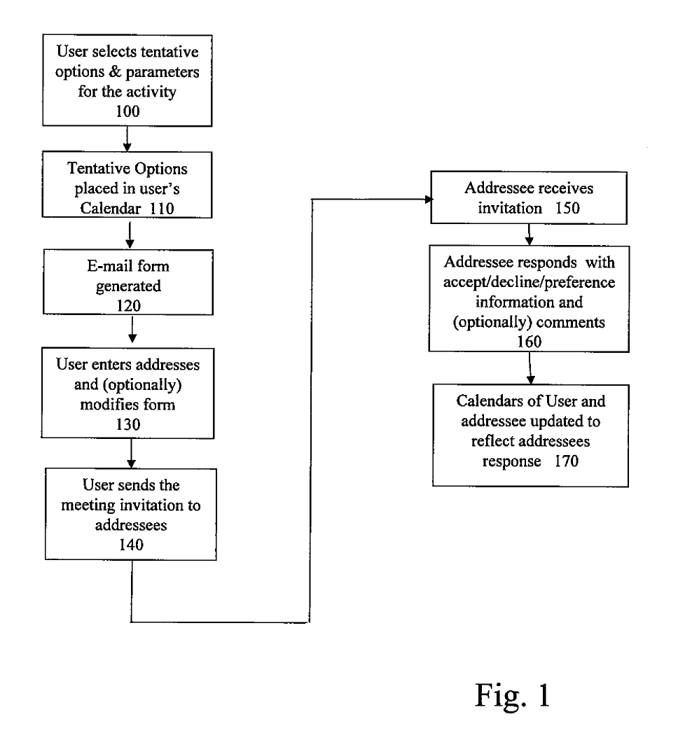

Reference is now made to FIG. 1, which is a flow chart showing a process of arranging an activity among a user and multiple invitees according to an embodiment of the present invention. In this example, the “user” is someone who is attempting to organize a meeting or other event. The user may or may not be a participant in the meeting/event. At step 100, the user specifies or selects proposed or tentative activity data such as a meeting/event title or purpose, location, duration and times (e.g., start time). As discussed further below, this data can be specified/selected using a computer-based software tool having graphical user interfaces that allow for text entry (e.g., via a keyboard or other input device), icon and element selection (e.g., selection from drop down lists, radio buttons, etc. using a cursor control device such as a mouse, track pad, etc.), highlighting, etc.

At step 110, this data specified/selected by the user is entered in an electronic calendar that is integrated with an e-mail program as part of a PIM software platform such as Microsoft Outlook™. The data placed in the user's calendar may include a single time, or, alternatively, several tentatively proposed times. The number of reserved time blocks is typically related to the number of invitees or perceived difficulty in finding a suitable time.

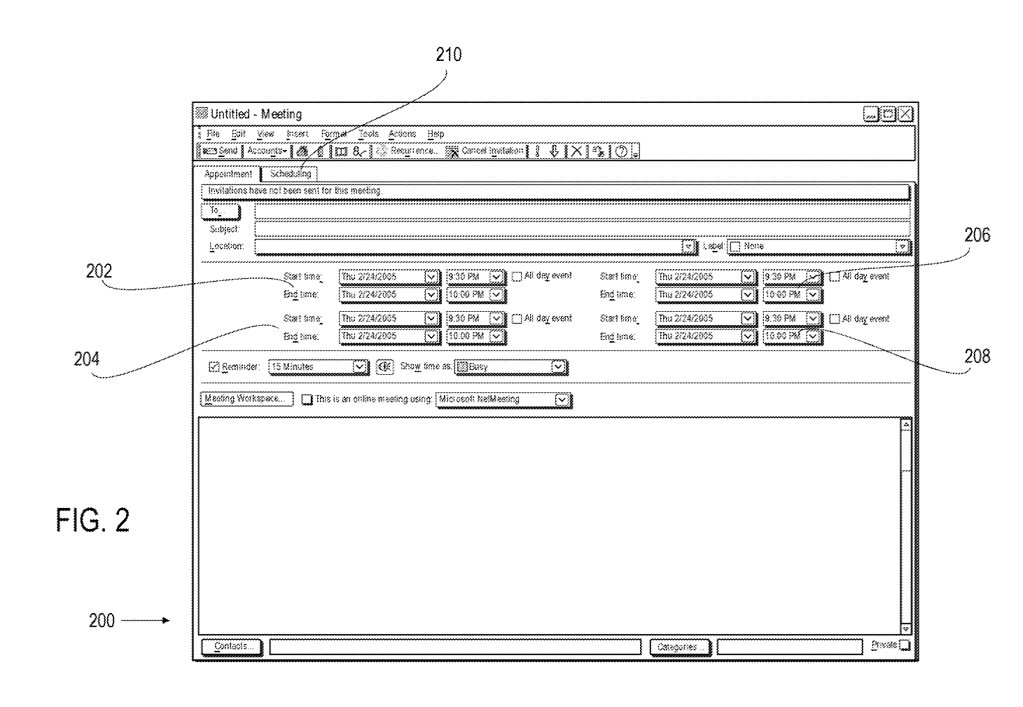

FIG. 2 is a screen shot showing an input screen or form 200 that may advantageously be presented to the user during steps 100 and 110. This input screen is generated by the PIM software in the conventional manner (e.g., in response to a cursor control action to initiate a new meeting request) and may be a Web form (in the case where the PIM supports such objects) or a native screen for the PIM application. The user may interact with this form to specify the tentative options such as preferred start and end times and dates, the invitees' e-mail addresses (or other identifying information) and other data pertinent to the meeting. In this example, four sets of start/end times/dates 202, 204, 206 and 208 have been entered using drop down lists (though in other embodiments elements such as text boxes, radio button fields, or combinations of same may be used. These sets of times/dates will ultimately be presented to the invitees as meeting options from which the invitees will be permitted to choose. Other elements of screen 1300 will be familiar to users of the Microsoft Outlook tool and so are not discussed further herein.

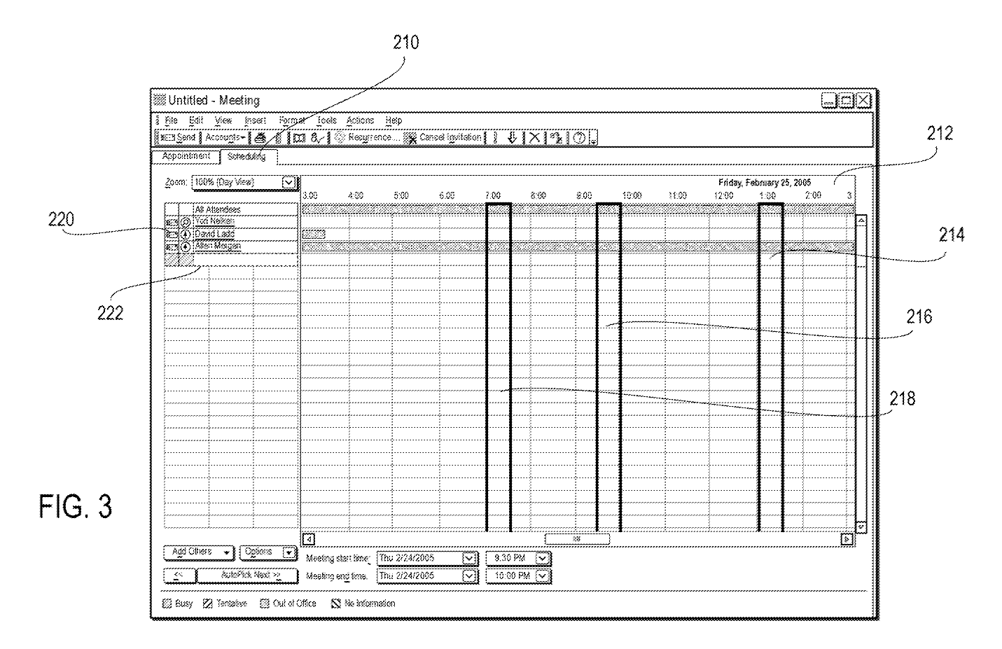

Screen 200 may be associated with a second “page”, accessible via the “Scheduling” tab 210. That is, by selecting Scheduling tab 210, the user is presented with the Scheduling page of form 200, shown in FIG. 3. As illustrated, the Scheduling page includes a calendar window 212 that resembles a timeline in which free/busy information for meeting participants is displayed. In this particular example, three tentative meeting options 214, 216 & 218 are shown in calendar window 212. The meeting options are overlaid on the timeline view and cut across the free/busy information for those meeting participants for which such free/busy information is available. The attendee list 220 is adjacent to window 212 and a link 222 is provided for adding additional invitees.

In this embodiment of the invention, meeting participants who are on the same network server can see each other's availability (i.e., free/busy information), and this information is rolled-up to the user's calendar interface for use in selecting tentative meeting times. That is, the user can select proposed meeting times that coincide with free time for one or more of the invitees, as reflected in the free/busy information displayed in calendar window 212. This methodology takes advantage of the available free/busy information provided by the common server. For example, the user is able to execute free/busy searches for any person willing to shares his/her calendar information on the same server.

In a further embodiment of the present invention, a server that is separate from the local network of the user and/or the invitees is used. Because of the privacy and security concerns associated with sharing calendar information across networks/organizations, this server is preferably operated by a trusted third party and is termed hereinafter the “trusted server”. The trusted server provides the ability for those who opt-in to share at least some portions of their free/busy calendar information with selected others from disparate networks.

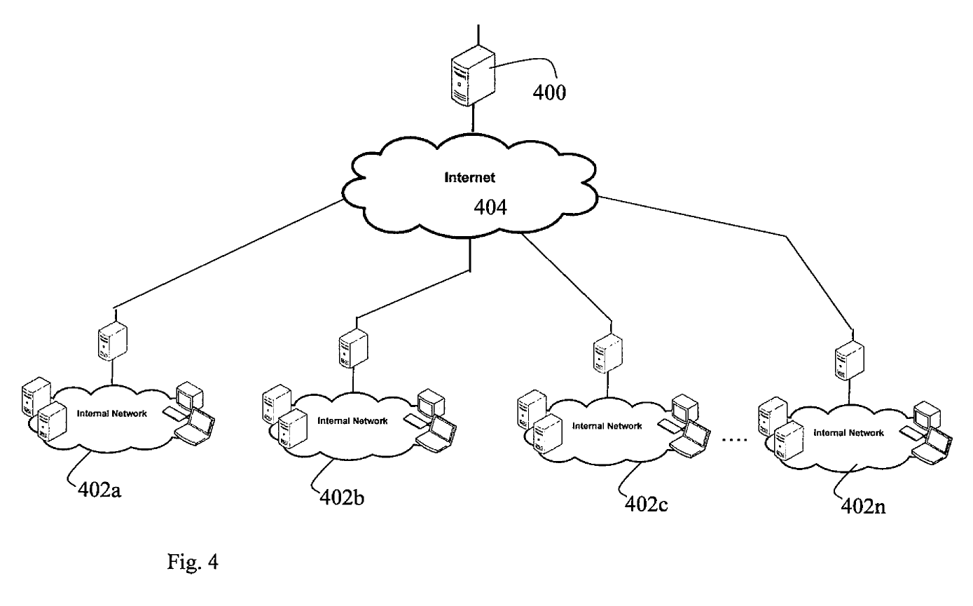

A schematic diagram illustrating the use of such a trusted server in connection with the present methods is shown in FIG. 4. The trusted server 400 is connected (e.g., by way of the Internet 404 or other computer network) to one or more enterprise (or other) networks 402a-402n. Often these networks will be associated with different enterprises, but that is not necessarily so. Hereinafter these networks will be referred to as “internal” networks so as to indicate that they are generally private to an enterprise and not “public” networks, such as the Internet (though one or more of the internal networks may support publicly available hosts).

One of the internal networks, for example 402a, may be the user's local network. As discussed above, within network 402a the user has access to and can share free/busy information with other members of network 402a. In accordance with the present invention, the user may further access the free/busy information of invitees on disparate networks 402b-402n, to the extent that each of those invitees permits such sharing. The means by which this occurs is described further below.

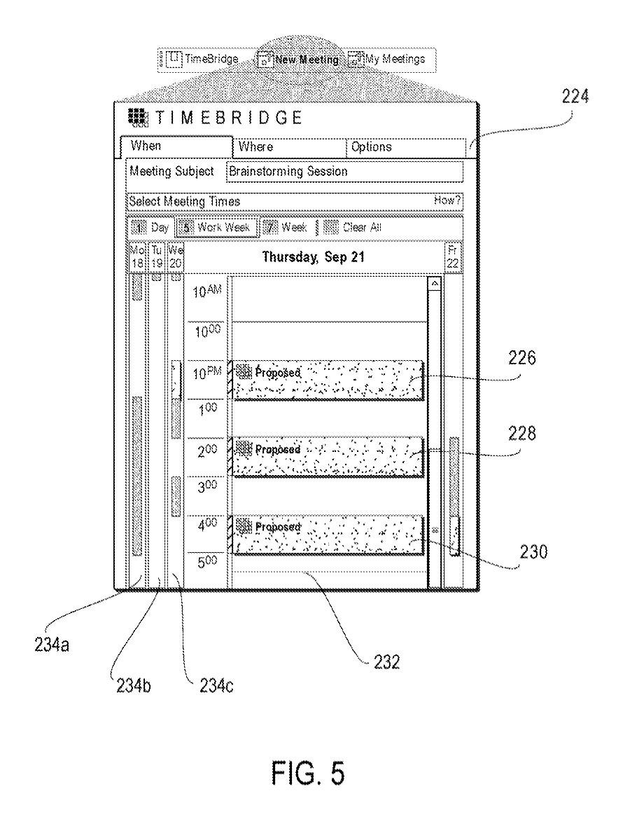

Returning now to FIG. 1, whether or not free/busy information for any invitee is available the meeting times selected by the user in step 100 are marked as tentative in the user's calendar. This may be done, for example, using color coding or other visual indicators to distinguish tentative activities from confirmed activities. In one embodiment of the present invention, shown in FIG. 5, these times are marked on the user's calendar along with other free/busy information pertinent to the user. FIG. 5 shows a calendar view 224 in which three tentative meeting times 226, 228 & 230 are displayed. The tentative meeting times may be color coded as Outlook™ tentative meetings. The tentative meeting times may be presented as alternative options for a proposed meeting, as discussed further below.

The free/busy information pertinent to the user advantageously includes free/busy information for at least some of the meeting invitees and may include others selected by the user. The information is preferably displayed in the format shown in FIG. 5, wherein appointments for a selected day, Thursday September 21 in this example, are shown in detail in an uncondensed day view 232 and free/busy information for “nearby” days are shown in abbreviated format in condensed day views 234a, 234b, 234c. This allows the user to quickly find days or times during, for example, a week when the user and one or more invitees each/all have free time. The free/busy information for the user and at least some invitees is obtained and combined or “rolled up” from at least a server common to these individuals and/or free/busy information available from the trusted server.

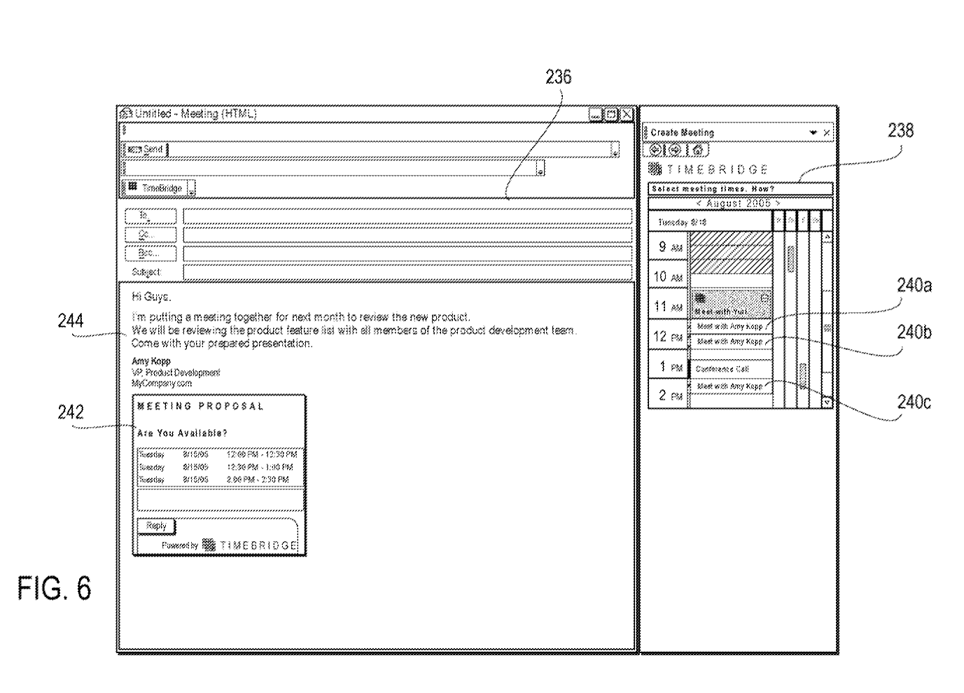

Referring again to FIG. 1, in step 120, in response to the user's selection of tentative meeting times, an e-mail form is automatically generated; the content of the form is based on the tentative calendar times specified by the user. FIG. 6 shows an example of such an e-mail form 236 and the associated calendar 238. In this example, the calendar 238 is presented with the uncondensed and condensed day views.

The proposed meeting times 240a, 240b and 240c are shown in the calendar 238 and also in the meeting proposal form 242 which is included in the e-mail form 236. This meeting proposal form 242 is automatically generated in response to the user specifying the tentative meeting times. The precise content of the meeting proposal form 242 is not critical to the present invention, but this form 242 and calendar 238 are preferably dynamically linked so that the information in the meeting proposal form changes automatically as the user selects, deletes or modifies proposed meeting times/dates within the calendar 238. Hence, the meeting proposal form 242 preferably includes the same date/time information as is reflected in the calendar 238, which the user used to plan and create the proposed meeting times. In addition, the meeting proposal form 242 is preferably presented to the user in the e-mail form 236 in the same format as it will be presented to the recipients of the e-mail message so that the user can edit the proposal as she/he sees fit. As will be described below, each recipient will be invited to reply with his/her individual availability status for each of the proposed meeting times/dates. This will help minimize the time required for negotiating the actual meeting time/date.

In addition to the meeting proposal form 242, the e-mail form 236 includes a comment field 244 in which the user can enter text or other information relating to the meeting request. This field resembles a conventional e-mail text field and so will not be described in further detail. As with conventional e-mails, signature blocks or other information may be automatically inserted in this field.

Returning again to FIG. 1, in step 130, the user enters addresses of invitees to be invited by e-mail. In some cases this information may be entered automatically as the user selects meeting invitees. The user also has the option of personalizing or otherwise modifying the message before sending it. In step 140 the user sends the e-mail with the meeting proposal form in the conventional fashion.

In addition to being provided to the individual invitees, the proposed meeting times/dates are also provided to the trusted server. At the trusted server a virtual meeting instance is created and populated with the proposed meeting times/dates created by the user. This virtual meeting instance will facilitate the collection of responses from the invitees and also the scheduling of the meeting based on the content of those responses.

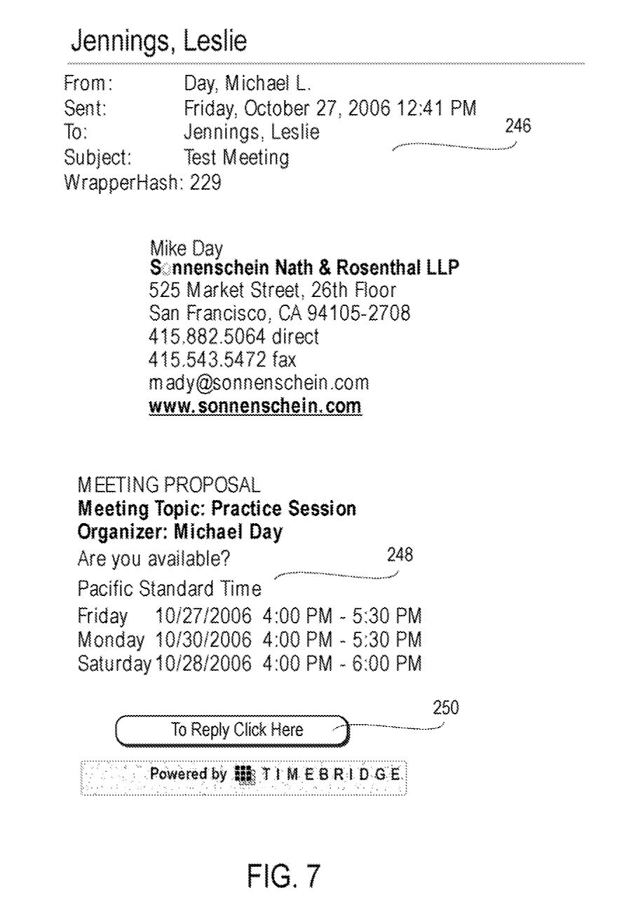

FIG. 1 also shows the process an invitee follows when receiving a meeting invitation and responding thereto. In accordance with the present invention, the invitee receives the meeting invitation as a conventional e-mail message at step 150. An example of such an e-mail message 246 is shown in FIG. 7.

The e-mail message 246 includes the conventional fields showing the sender, date and time of transmission, the recipients and subject and a text field in which the sender has included comments. In addition, the e-mail message 246 includes the meeting proposal field 248 with the proposed meeting times that were generated when the sender constructed tentative meeting times using his/her calendar. A hyperlink 250 is embedded within the body of the e-mail message 246 (or form 248), which link solicits a response from the invitee to the proposed meeting times. The invitee's preparation of a response to the meeting invitation is provided for at step 160 of the process illustrated in FIG. 1.

The use of conventional e-mail to facilitate this solicitation for a response by the invitee to the proposed meeting times means that the invitee is not required to employ the same PIM software as the user, nor necessarily be connected to the same server. Moreover, the present invention avoids drawbacks associated with requiring the invitee to install any plug-ins, utilities or other software applications in order to take advantage of the invention. Instead, the invitee is able to use his/her conventional e-mail software (or Web-based e-mail accounts) to view the e-mail containing the meeting proposal and his/her conventional Web browser to respond thereto.

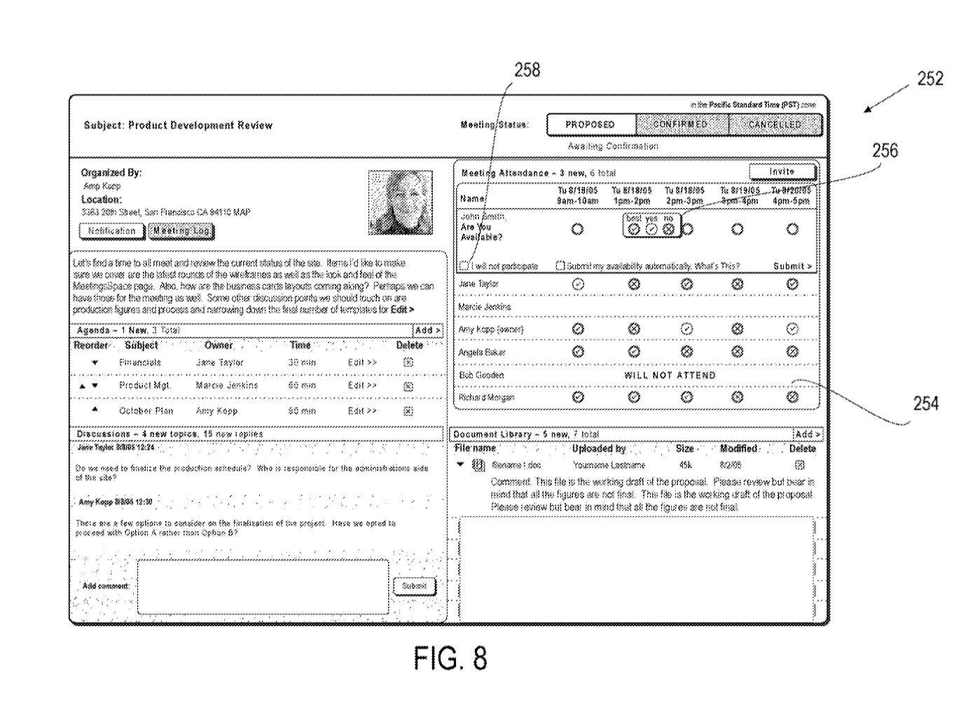

Upon selecting the link 250 included in the e-mail message 246, the invitee's Web browser is launched and directed to a Web page associated with the trusted server. This Web page is associated with the meeting proposal included in the e-mail message that was transmitted to the invitee. An example of such a Web page 252 is shown in FIG. 8.

Web page 252 includes a form 254 which lists each of the proposed meeting times that were specified in the original meeting proposal. Accompanying each proposed meeting time/date are means for the invitees to respond thereto. For example, the invitees may be permitted to accept or decline each proposed time/date for the meeting. In one embodiment, each invitee is further permitted to indicate which time(s)/date(s) are preferred for the meeting (i.e., which are the best or most preferable choices for that invitee). Such choices may be provided for using convention web form elements such as radio buttons, drop down lists, text boxes, check boxes and the like. The invitee may also be given the option to indicate he/she will not participate in the meeting at all.

In the example of the Web page shown in FIG. 8, the invitee is able to accept, decline or indicate his/her preference for each of the proposed meeting times/dates by selecting and clicking on radio buttons 256. Alternately, the invitee may respond by selecting check box 258 to indicate that s/he will not participate in the meeting. The selections of other meeting invitees and the organizer may or may not be presented to each individual invitee (e.g., in a grid fashion associated with the name of the meeting invitee/organizer). In addition to providing for this selection of preferred meeting times/dates, the Web page 252 may include means and fields for the invitee to contribute discussion, agenda items and/or documents along with the invitee's response. In this way the Web page 252 becomes a shared meeting space that can facilitate the exchange of more than just availability information for the meeting participants.

Once all of the invitees have responded to their solicitations and indicated their preferences and availabilities for the proposed meeting, the trusted server schedules the meeting. The precise means or algorithms used to perform such scheduling are not critical to the present invention. A scheduling algorithm that determines a “best fit” from among the individual invitee's responses may be employed for such purposes. Alternatively, a scheduling algorithm that selects the first available meeting time/date at which all or most of the meeting participants will be available may be used. Or, the trusted server may confirm meetings according to user-defined criteria for such confirmation.

Regardless of what form of scheduling algorithm is used, however, upon such scheduling the meeting initiator and, optionally, the invitees may be informed of the scheduling of the meeting (e.g., by way of an e-mail transmitted from the trusted server). Alternately, the user may prefer that meetings be finally confirmed only manually, as, for example when the attendance of a necessary invitee cannot be confirmed by the trusted server.

In addition to confirming the successful scheduling of the meeting, the trusted server may also automatically update the meeting initiator's (and, optionally, the invitees') calendar(s) to reflect the present status of the proposed meeting times/dates as the meeting invitees respond with their individual preferences. For example, and referring again to FIG. 1, at step 170 the user's calendar is automatically updated to reflect individual invitees' responses to the proposed meeting times/dates. Depending on the user's preferences, tentative meeting times may be deleted or confirmed based on the responses of one or more invitees. For example, the user may opt to have a meeting “confirmed” when a plurality of invitees confirm a particular time/date, or only when unanimity is reached. Optionally, the user may be appraised of the invitees' individual responses by way of e-mail from the trusted server.

Although the invention has been described in conjunction with specific embodiments thereof, it is evident that many alternatives, modifications and variations will be apparent to those skilled in the art. For example, although the present invention has been described with reference to existing enterprise e-mail applications, the present methods may be practiced without the use of such tools and instead may make use of Web-based e-mail solutions. In such cases, the appearance of the interfaces described above may differ, but the functionality afforded by those interfaces will remain. Accordingly, it is intended to embrace all such alternatives, modifications and variations that fall within the spirit and broad scope of the appended claims,

What is claimed is:

1. A computer-implemented method, comprising:
reserving, in an electronic calendar and in response to selection by the user of one or more proposed meeting times and dates in said calendar, blocks of time reflecting the user's selection as proposed meeting times/dates;
creating, contemporaneously with the user's selections, an e-mail form specifying the proposed meeting times and dates; and
transmitting, in response to user command, the e-mail form specifying the proposed meeting times and dates to the one or more invitees.

2. The method of claim 1, further comprising transmitting the proposed meeting times and dates to a server and creating, at the server, a virtual meeting instance according to the proposed meeting times and dates.

3. A graphical user interface, comprising an e-mail form and a dynamically linked calendar view, the calendar view permitting selection by a user of one or more times/dates for a multi-person event and the e-mail form including a proposed meeting form that is dynamically updated to reflect the user's selection of the one or more times/dates for the multi-person event.

4. The graphical user interface of claim 3, wherein the calendar view comprises an uncondensed view of at least a portion of a selected day and a condensed view of multiple adjacent days to the selected day, each view including the user's free/busy time for a respective day.

5. The graphical user interface of claim 3, wherein the email form further includes a field for text to be entered by the user.

6. A computer-implemented method, comprising updating a user's electronic calendar to reflect selections by one or more meeting invitees of proposed meeting times/dates, said selections being made through a server other than that hosting an instance of the user's electronic calendar.

7. The method of claim 6, wherein, the selections by the meeting invitee's comprise acceptance, rejection, or preference indications concerning the proposed meeting times/dates.

8. The method of claim 6, wherein the proposed meeting times are presented to the invitees via e-mail messages soliciting responses to the proposed meeting times/dates.

9. The method of claim 8, wherein the e-mail messages include proposed meeting fields that include the proposed meeting times/dates, which proposed meeting times/dates are entered in the proposed meeting fields automatically in response to user selection of said proposed meeting times/dates in the user's electronic calendar.

10. The method of claim 9, wherein a view of the user's electronic calendar is presented concurrently with a e-mail form including the proposed meeting fields so as to facilitate the user selection of said proposed meeting times/dates.
